(19) United States
(12) Patent Application Publication
(10) Pub. No.: US 2022/0014819 A1
(43) Pub. Date: Jan. 13, 2022

(54) VIDEO IMAGE PROCESSING

(71) Applicant: GUANGZHOU HUYA INFORMATION TECHNOLOGY CO., LTD., Guangdong (CN)

(72) Inventors: Jianqiang LIU, Guangdong (CN); Dongzhu WANG, Guangdong (CN); Xiaodong WU, Guangdong (CN); Hao WU, Guangdong (CN)

(73) Assignee: GUANGZHOU HUYA INFORMATION TECHNOLOGY CO., LTD., Guangdong (CN)

(21) Appl. No.: 17/266,833

(22) PCT Filed: Aug. 14, 2019
(86) PCT No.: PCT/CN2019/100528

§ 371 Date: Aug. 24, 2021

(30) Foreign Application Priority Data
Aug. 14, 2018 (CN) 201810925080.X

(51) Int. Cl. H04N 21/44; H04N 19/132; H04N 21/431; H04N 21/2187

(52) U.S. Cl. CPC H04N 21/44008; H04N 21/2187; H04N 21/4316; H04N 19/132

(57) ABSTRACT

A video image processing method includes: acquiring first video images; generating mask information of the first video images in response to a mask information generation command; and transmitting the first video images and the mask information to an audience client, such that the audience client obtains second video images according to the first video images and the mask information.

### CROSS-REFERENCE TO RELATED APPLICATIONS

The present patent application claims a priority of the Chinese patent application No. 201810925080X filed on Aug. 14, 2018 and entitled “LIVE VIDEO IMAGE PROCESSING METHOD AND APPARATUS, STORAGE MEDIUM AND COMPUTER DEVICE”, which is incorporated herein by reference in its entirety.

### TECHNICAL FIELD

The present disclosure relates to video image processing.

### BACKGROUND

With the development of technology, live-streaming applications emerge in endlessly. A host may share his/her life through the live streaming applications, and an audience may watch contents they are interested in through the live-streaming applications. In a live-streaming process, the current solution is generally that the host records a video content that he/she wants to share, and then transmits the video content to the audience through a server, and what the audience watches is the video content actually shared by the host. The content of the live video played in this way is relatively monotonous, resulting in a poor playing effect of the live video.

### SUMMARY

In view of this, the present disclosure provides a video image processing method and apparatus, a storage medium and a computer device.

According to a first aspect of embodiments of the present disclosure, there is provided a video image processing method including: acquiring first video images; generating mask information of the first video images in response to a mask information generation command; and transmitting the first video images and the mask information to an audience client, such that the audience client obtains second video images according to the first video images and the mask information.

According to a second aspect of the embodiments of the present disclosure, there is also provided another video image processing method including: receiving first video images and mask information of the first video images from a host client or a server; and obtaining second video images according to the first video images and the mask information.

According to a third aspect of the embodiments of the present disclosure, there is also provided a video image processing apparatus including: a first video image acquiring module, configured to acquire first video images; a mask information generating module, configured to generate mask information of the first video images in response to a mask information generation command; and a transmitting module, configured to transmit the first video images and the mask information to an audience client, such that the audience client obtains second video images according to the first video images and the mask information.

According to a fourth aspect of the embodiments of the present disclosure, there is also provided another video image processing apparatus including: a receiving module, configured to receive first video images and mask information of the first video images from a host client or a server; and a second video image obtaining module, configured to obtain second video images according to the first video images and the mask information.

According to a fifth aspect of the embodiments of the present disclosure, there is also provided a computer-readable storage medium in which a computer program is stored, wherein the computer program, when executed by a processor, causes the processor to implement the above video image processing method.

According to a sixth aspect of the embodiments of the present disclosure, there is also provided a computer device including: one or more processors; and a memory configured to store one or more programs, wherein the one or more programs, when executed by the one or more processors, cause the one or more processors to implement the above video image processing method.

### BRIEF DESCRIPTION OF DRAWINGS

FIG. 1 is a schematic diagram of an application environment for a live video image processing method according to an embodiment of the present disclosure.

FIG. 2 is a schematic flowchart of a live video image processing method according to an embodiment of the present disclosure.

FIG. 3 is a schematic flowchart of a method of transmitting first live video images and mask information according to an embodiment of the present disclosure.

FIG. 4 is a schematic flowchart of a method of transmitting first live video images and mask information according to another embodiment of the present disclosure.

FIG. 5 is a schematic flowchart of a method of transmitting first live video images and mask information according to still another embodiment of the present disclosure.

FIG. 6 is a schematic flowchart of a method of transmitting first live video images and mask information according to yet another embodiment of the present disclosure.

FIG. 7 is a schematic structural diagram of a live video image processing apparatus according to an embodiment of the present disclosure.

FIG. 8 is a schematic flowchart of a live video image processing method according to another embodiment of the present disclosure.

FIG. 9 is a schematic flowchart of a method of receiving first live video images and mask information according to an embodiment of the present disclosure.

FIG. 10 is a schematic flowchart of a method of receiving first live video images and mask information according to another embodiment of the present disclosure.

FIG. 11 is a schematic flowchart of a method of receiving first live video images and mask information according to still another embodiment of the present disclosure.

FIG. 12 is a schematic flowchart of a method of receiving first live video images and mask information according to yet another embodiment of the present disclosure.

FIG. 13 is a schematic structural diagram of a live video image processing apparatus according to another embodiment of the present disclosure.

FIG. 14 is a schematic structural diagram of a computer device according to an embodiment of the present disclosure.

### DETAILED DESCRIPTION

Embodiments of the present disclosure will be described in detail below, with the illustrations thereof represented in the drawings, in which like or similar numerals refer to like or similar elements or elements with like or similar functions. The embodiments described below with reference to the drawings are exemplary, are merely used to explain the present disclosure, and cannot be construed as limiting the present disclosure.

Those skilled in the art may understand that, terms determined by “a”, “an”, “the” and “said” in their singular forms used herein may also include plurality or multiple, unless specifically stated otherwise. It should be further understood that, the term “including” used in the specification of the present disclosure refers to the presence of the stated features, integers, steps, operations, elements and/or components, but does not exclude the presence or addition of one or more other features, integers, steps, operations, elements, components and/or a combination thereof.

It is to be understood that, although terms “first”, “second” and the like used in the present disclosure may be used herein to describe various elements, such elements should not be limited by these terms. These terms are only used to distinguish the first element from another element. For example, without departing from the scope of the present disclosure, first live video image may be referred to as second live video image; and similarly, second live video image may be referred to as first live video image. Both the first live video image and the second live video image are live video images, but they are not the same live video image.

Those skilled in the art may understand that, unless otherwise defined, all terms (including technical and scientific terms) used herein have the same meanings as those generally understood by those ordinary skilled in the art to which the present disclosure pertains. It should also be understood that, in the present disclosure, terms such as those defined in general dictionaries, unless specifically defined, should be understood to have meanings consistent with their meanings in the prior art.

Those skilled in the art may understand that, the client used herein includes both a device with a wireless signal receiver, which can receive wireless signals without any transmission capability, and a device with a receiving and transmitting hardware, which can perform bidirectional communication on a bidirectional communication link. The client may include: a cellular or other communication device with a single-line display or a multi-line display or with no multi-line display; a PCS (Personal Communications Service), which may combine voice, data processing, fax and/or data communication capability; a PDA (Personal Digital Assistant), which may include a radio frequency receiver, a pager, Internet/Intranet access, a web browser, a notepad, a calendar and/or a GPS (Global Positioning System) receiver; and a conventional laptop and/or palmtop computer or other device that has and/or includes a radio frequency receiver. The client used herein may be portable, transportable, and installed in (air, sea and/or land) vehicles, or be suitable for and/or configured to operate locally, and/or in a distributed form, at any other location of the earth and/or space. The client used herein may further include a communication terminal, an Internet access terminal, a music/video player terminal, for example, a PDA, an MID (Mobile Internet Device) and/or a mobile phone with a music/video playing function, and may also include a device such as a smart TV and a set-top box.

Those skilled in the art may understand that, the server used herein includes but is not limited to, a computer, a network host, a single network server, a set of multiple network servers, or a cloud including multiple servers. Here, the cloud may include a large number of computers or network servers based on cloud computing. The cloud computing, as a type of distributed computing, is a super virtual computer composed of a cluster of loosely coupled computer sets. In the embodiments of the present disclosure, the client may communicate with the server in any communication manner, including but not limited to, mobile communication, computer network communication, and short-range wireless transmission manners based on Bluetooth and infrared transmission standards.

The technical solutions according to the present disclosure will be described below in conjunction with specific embodiments. It should be noted that the embodiments involved in the present disclosure may be implemented during a live-streaming process or during a playback process. The playback process may occur during the live-streaming process, or after the live-streaming process ends.

Taking the live-streaming process as an example, a live video image processing method according to the embodiments of the present disclosure may be applied to a hardware environment including a host client 11, a server 12, and an audience client 13 as shown in FIG. 1. As shown in FIG. 1, the host client 11 and the server 12 may be connected through a network, and the server 12 and the audience client 13 may be connected through a network. The host client 11 or the server 12 may transmit a first live video image and mask information of the first live video image to the audience client 13 during the live-streaming process, and the audience client 13 may process the first live video image based on the mask information to generate a second live video image for display.

Firstly, specific implementations of the live video image processing method and apparatus according to the present disclosure will be described in detail, from the perspective of the host client or the server.

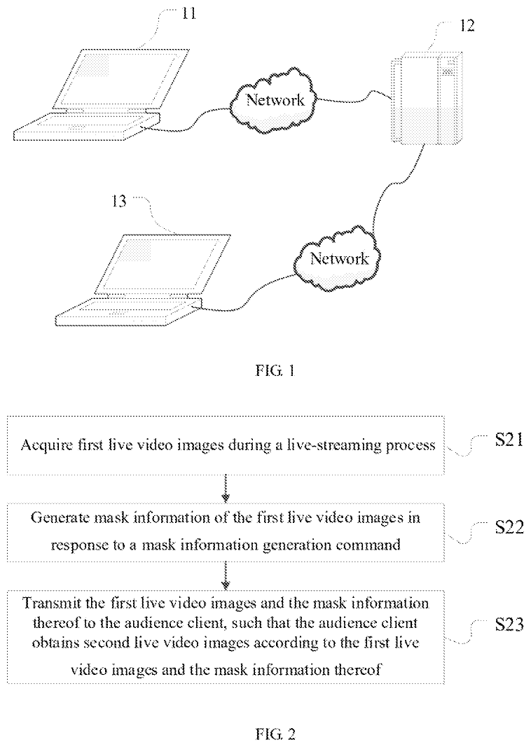

As shown in FIG. 2, in an embodiment, a live video image processing method includes steps S21-S23.

At step S21, first live video images are acquired during a live-streaming process.

A first live video image may include a live video image recorded by the host client in real time, and may further include a bullet screen comment uploaded by the audience client, etc. The bullet screen comment refers to a commentary subtitle that pops up when watching a live video through a live-streaming application. The host client collects live video images through the live-streaming application to obtain the live video images. If the method according to this embodiment is executed on the host client, the first live video images refer to the live video images collected by the host client. If the method according to this embodiment is executed on the server, the first live video images refer to the live video images transmitted from the host client to the server.

At step S22, mask information of the first live video images is generated in response to a mask information generation command.

The mask information is a vector graphic and/or bitmap of a contour of a target object. The vector graphic, also called object-oriented image or drawing image, is an image represented by geometric primitives based on mathematical equations such as points, lines, or polygons in computer graphics. The bitmap is also called dot matrix image or pixel image. Pictures on a computer screen are all composed of light-emitting points (i.e., pixels) on the screen, and information of each point such as color and brightness is described with binary data. These points are discrete, similar to a dot matrix. A color combination of multiple pixels forms an image, which is called a bitmap. The required number of bytes for the vector graphic and the bitmap may be controlled by parameters.

There are many ways to obtain the mask information generation command. For example, a trigger button may be provided for the mask information generation command, and a user may input the mask information generation command by clicking the trigger button. For another example, the user may input touch information generation command through voice or in other ways. For still another example, a trigger condition may be set for the mask information generation command, and when it is detected that the trigger condition is met, the mask information generation command may be automatically input. By inputting the mask information generation command during the live-streaming process, the mask information may be generated in real time, and the audience client may adjust the first live video images in real time based on the mask information subsequently.

The mask information of the first live video image may be used to identify which areas are foreground areas and which areas are background areas. A mask image that is the same as the first live video image may be created, a pixel value of a foreground area in the mask image may be set to a first value, for example, 1, and a pixel value of a background area in the mask image may be set to a second value, for example, 0, through an algorithm, such that the mask information of the first live video image may be obtained. The algorithm may be implemented by using an algorithm already existing in the related art, such as a foreground-background separation technology or a target detection technology. If the method according to this embodiment is executed on the host client, the host client invokes the algorithm to generate the mask information. If the method according to this embodiment is executed on the server, the server invokes the algorithm to generate the mask information when transcoding.

At step S23, the first live video images and the mask information thereof are transmitted to the audience client, such that the audience client obtains second live video images according to the first live video images and the mask information thereof.

After the mask information is generated, the first live video images may be transmitted to the audience client together with the mask information thereof, such that the audience client may adjust the first live video images based on the mask information to obtain the second live video images for display on the audience client.

In order to better understand the process of adjusting the first live video images based on the mask information, the description will be given in conjunction with two examples. As an example, if the user wants to change a background of the first live video image, for example, to replace the background with a background having a special effect, a stylized background, a real-scene background, a game background, and the like, he/she may cut out a foreground area image of the first live video image based on the mask information, and then superimpose the foreground area image on the replacement background for display. As another example, if the user wants to change a foreground in the first live video image to a preset picture, for example, the foreground is an image of the host and the user wants to change it to his/her own image, he/she may cut out a background area image of the first live video image based on the mask information, and then superimpose the replacement image on the cutout background area image for display.

The live video image processing method according to this embodiment meets diversified needs of users, increases interest and enjoyment of a live streaming, improves user watching experience, and improves a playing effect of a live video.

There are many ways to transmit the first live video images and the mask information thereof to the audience client, which will be described below with reference to four embodiments. It should be understood that the present disclosure is not limited to the following four embodiments, and the user may transmit the first live video images and the mask information thereof to the audience client in other ways.

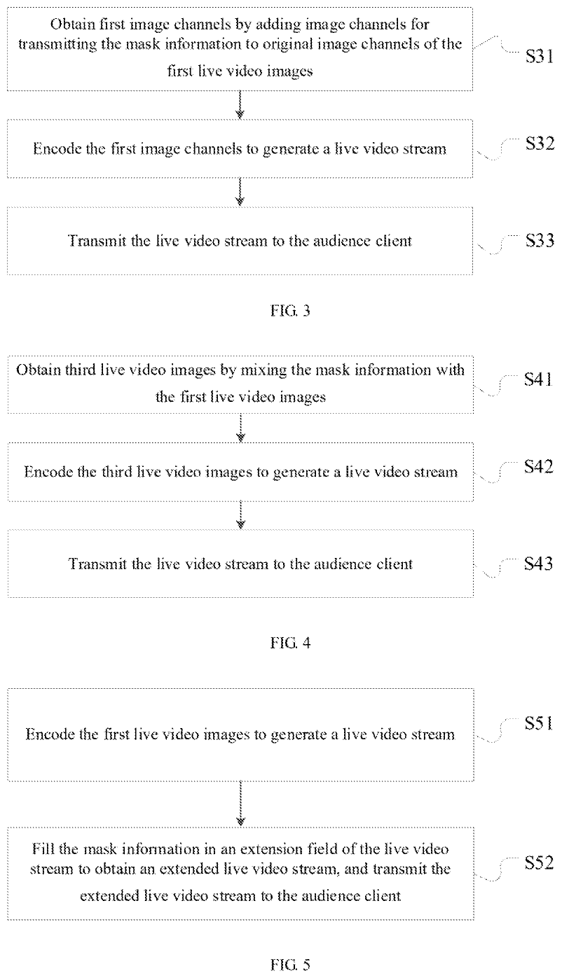

As shown in FIG. 3, in an embodiment, transmitting the first live video images and the mask information thereof to the audience client may include steps S31-S33.

At step S31, first image channels are obtained by adding image channels for transmitting the mask information to original image channels of the first live video images.

A complete image may generally include three channels, that is, a red channel, a green channel and a blue channel, which work together to produce the complete image. The original image channels of the first live video image may generally refer to the three channels, i.e., the red channel, the green channel and the blue channel. A new image channel may be added on the basis of the three channels, and the added image channel may be used to transmit the mask information. The specific method of adding the new image channel may be implemented according to a method already existing in the related art.

At step S32, the first image channels are encoded to generate a live video stream.

The images transmitted based on the original image channels and the added image channels may be simultaneously encoded to generate the live video stream. Optionally, the live video stream may be a standard live video stream, such as H264, MPEG, H26X, and so on.

At step S33, the live video stream is transmitted to the audience client.

The generated live video stream may include not only information of the first live video images, but also the mask information. The live video stream may be transmitted to the audience client, such that the audience client may adjust the first live video images according to the mask information in the live video stream.

As shown in FIG. 4, in an embodiment, transmitting the first live video images and the mask information thereof to the audience client may include steps S41-S43.

At step S41, third live video images are obtained by mixing the mask information with the first live video images.

The mask information may be added to data of the first live video images to obtain data of the third live video images. There are many ways to add the mask information, which will be described below in conjunction with two embodiments. It should be understood that the present disclosure is not limited to the following two ways, and the user may mix the mask information with the data of the first live video images in other ways.

In an embodiment, obtaining the third live video images by mixing the mask information with the first live video images may include steps S411 and S412.

At step S411, a color space conversion is performed on the first live video images to vacate bits in image areas of the first live video images.

There are many kinds of color space, and the commonly used ones are RGB (Red, Green, Blue), YUV (Luminance, Chrominance, Chroma), CMY (Cyan, Magenta, Yellow), and so on.

The color space conversion may be performed on the first live video image, that is, the first live video image may be converted from one color mode to another color mode to vacate a bit to represent the mask information. For example, the first live video image may be converted from an RGB mode to a YUV420 mode, and transmitted in a YUV444 mode, such that several bits may be vacated for the mask information to fill in.

At step S412, the mask information is filled in the vacated bits to obtain the third live video images.

A bit may be vacated for the mask information to fill in, such that the mask information and the data of the first live video image may be mixed together to obtain the data of the third live video image.

In another embodiment, obtaining the third live video images by mixing the mask information with the first live video images may include steps S41a and S41b.

At step S41a, resolutions or image sizes of the first live video images may be reduced to vacate space in image areas of the first live video images.

The resolution of the first live video image may be reduced, that is, the resolution of the first live video image may be changed from an original resolution to a lower resolution, so as to vacate space for the mask information to fill in. Alternatively, the image size of the first live video image may be reduced by cropping, that is, the image size of the first live video image may be changed from an original image size to a smaller image size, so as to vacate space for the mask information to fill in.

At step S41b, the mask information is filled in the vacated space to obtain the third live video images.

Space may be vacated for the mask information to fill in, such that the mask information and the data of the first live video images may be mixed together to obtain the data of the third live video images.

At step S42, the third live video images are encoded to generate a live video stream.

The live video stream may be generated by encoding the third live video images, Optionally, the live video stream may be a standard live video stream, such as H264, MPEG, H26X, and so on.

At step S43, the live video stream is transmitted to the audience client.

The generated live video stream may include not only information of the first live video images, but also the mask information. The live video stream may be transmitted to the audience client, such that the audience client may adjust the first live video images according to the mask information in the live video stream.

As shown in FIG. 5, in an embodiment, transmitting the first live video images and the mask information thereof to the audience client may include steps S51 and S52.

At step S51, the first live video images are encoded to generate a live video stream.

The live video stream may be generated by encoding the first live video images. Optionally, the live video stream may be a standard live video stream, such as H264, MPEG, H26X, and so on.

At step S52, the mask information is filled in an extension field of the live video stream to obtain an extended live video stream, and the extended live video stream is transmitted to the audience client.

With the mask information attached to the extension field of the live video stream, the live video stream may include not only the data of the first live video images, but also the mask information. The live video stream may be transmitted to the audience client, such that the audience client may adjust the first live video images according to the mask information in the live video stream.

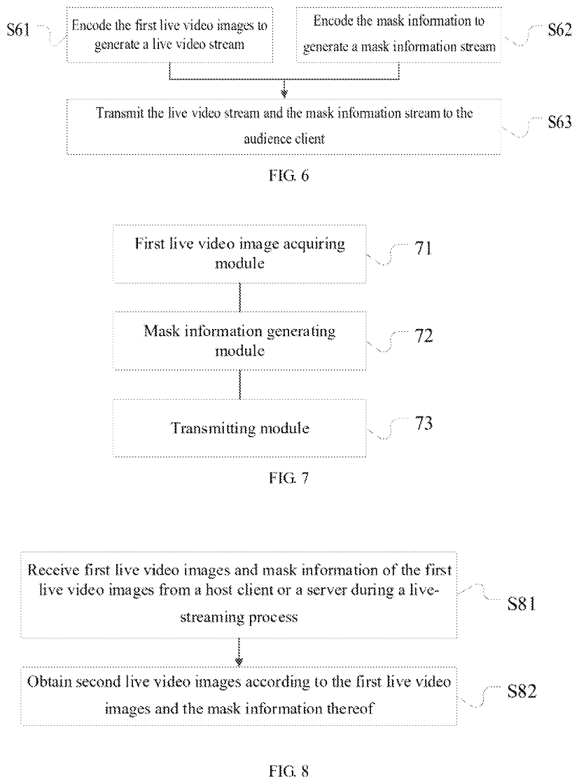

As shown in FIG. 6, in an embodiment, transmitting the first live video images and the mask information thereof to the audience client may include steps S61-S63.

At step S61, the first live video images are encoded to generate a live video stream.

The live video stream may be generated by encoding the first live video images. Optionally, the live video stream may be a standard live video stream, such as H264, MPEG, H26X, and so on.

At step S62, the mask information is encoded to generate a mask information stream.

The mask information stream may be generated encoding the mask information separately.

At step S63, the live video stream and the mask information stream are transmitted to the audience client.

Both of the live video stream and the mask information stream may be transmitted to the audience client, such that the audience client may adjust the first live video images in the live video stream according to the mask information stream.

Based on the same inventive concept, the present disclosure also provides a live video image processing apparatus. Specific implementations of the apparatus according to the present disclosure will be described in detail below with reference to the drawings.

As shown in FIG. 7, in an embodiment, a live video image processing apparatus includes:

a first live video image acquiring module 71, configured to acquire first live video images during a live-streaming process;

a mask information generating module 72, configured to generate mask information of the first live video images in response to a mask information generation command; and

a transmitting module 73, configured to transmit the first live video images and the mask information thereof to an audience client, such that the audience client obtains second live video images according to the first live video images and the mask information thereof.

In an embodiment, the transmitting module 73 may include: a first image channel obtaining unit, configured to obtain first image channels by adding image channels for transmitting the mask information to original image channels of the first live video images; a live video stream generating unit, configured to encode the first image channels to generate a live video stream; and a live video stream transmitting unit, configured to transmit the live video stream to the audience client.

In another embodiment, the transmitting module 73 may include: a third live video image obtaining unit, configured to mix the mask information with the first live video images to obtain third live video images; a live video stream generating unit, configured to encode the third live video images to generate a live video stream; and a live video stream transmitting unit, configured to transmit the live video stream to the audience client.

The third live video image obtaining unit may be configured to perform a color space conversion on the first live video images to vacate bits in image areas of the first live video images; and fill the mask information in the vacated bits to obtain the third live video images.

Alternatively, the third live video image obtaining unit may be configured to reduce resolutions or image sizes of the first live video images to vacate space in image areas of the first live video images; and fill the mask information in the vacated space to obtain the third live video images.

In still another embodiment, the transmitting module 73 may include: a live video stream generating unit, configured to encode the first live video images to generate a live video stream; and a transmitting unit, configured to fill the mask information in an extension field of the live video stream to obtain an extended live video stream, and transmit the extended live video stream to the audience client.

In yet another embodiment, the transmitting module 73 may include: a live video stream generating unit, configured to encode the first live video images to generate a live video stream; a mask information stream generating unit, configured to encode the mask information to generate a mask information stream; and a transmitting unit, configured to transmit the live video stream and the mask information stream to the audience client.

Next, specific implementations of the live video image processing method and apparatus according to the present disclosure will be described in detail, from the perspective of the audience client. It should be noted that the embodiments involved in the present disclosure may be implemented during the live-streaming process or during the playback process. The playback process may occur during the live-streaming process, or after the live-streaming process ends.

The following description is given taking the live-streaming process as an example.

As shown in FIG. 8, in an embodiment, a live video image processing method includes steps S81 and S82.

At step S81, first live video images and mask information of the first live video images are received from a host client or a server during a live-streaming process.

For the description of the first live video image and the mask information thereof, reference may be made to the description in steps S21 and S22, which will not be repeated herein.

At step S82, second live video images are obtained according to the first live video images and the mask information thereof.

The audience client may then adjust the first live video images based on the mask information to obtain the second live video images for display on the audience client.

The live video image processing method according to this embodiment meets diversified needs of users, increases interest and enjoyment of a live streaming, improves user watching experience, and improves a playing effect of a live video.

Corresponding to the aforementioned four ways of transmitting the first live video images and the mask information, the audience client needs to perform corresponding decoding operations to obtain the first live video images and the mask information transmitted from the host client. The following description will be given in conjunction with four embodiments.

As shown in FIG. 9, in an embodiment, receiving first live video images and mask information of the first live video images from a host client or a server during a live-streaming process may include steps S91-S94.

At step S91, a live video stream is received from the host client during the live-streaming process, where the live video stream is generated by encoding first image channels, and the first image channels are obtained by adding image channels for transmitting the mask information to original image channels of the first live video images.

At step S92, the live video stream is decoded to obtain the original image channels of the first live video images and the image channels for transmitting the mask information.

Since the live video stream is obtained by simultaneously encoding images transmitted in the original image channels and the added image channels, the original image channels of the first live video images and the image channels for transmitting the mask information may be obtained by decoding the live video stream.

At step S93, the first live video images are acquired from the original image channels of the first live video images.

The original image channels of the first live video images are used for transmitting the first live video images, thus the first live video images may be acquired from the original image channels.

At step S94, the mask information is acquired from the image channels for transmitting the mask information.

The added image channels are used for transmitting the mask information, thus the mask information may be acquired from the added image channels.

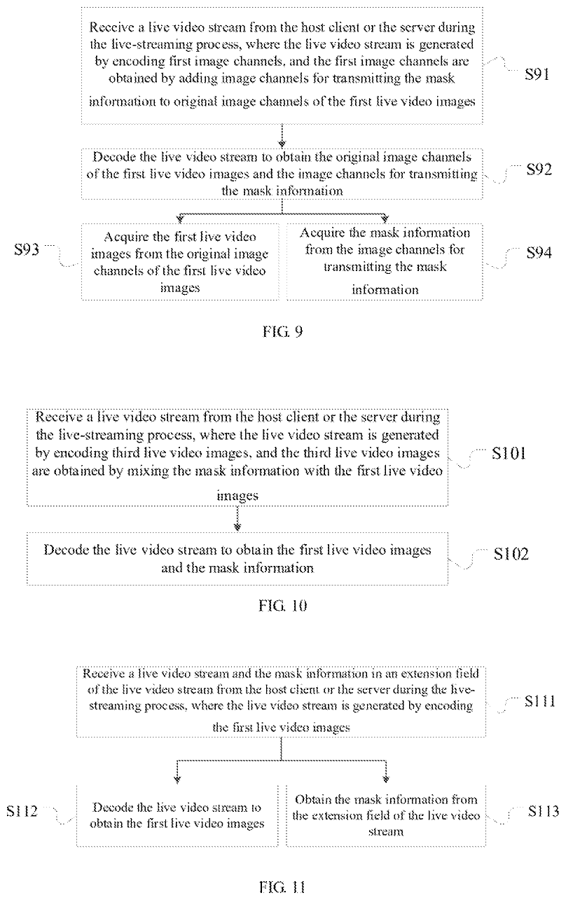

As shown in FIG. 10, in an embodiment, receiving first live video images and mask information of the first live video images from a host client or a server during a live-streaming process may include steps S101 and S102.

At step S101, a live video stream is received from the host client during the live-streaming process, where the live video stream is generated by encoding third live video images, and the third live video images are obtained by mixing the mask information with the first live video images.

The mask information may be added to data of the first live video images to obtain data of the third live video images. The third live video images may be encoded to generate the live video stream. The audience client may receive the live video stream.

At step S102, the live video stream is decoded to obtain the first live video images and the mask information.

Different ways of adding the mask information lead to different ways of decoding, which will be described below in conjunction with two embodiments.

In an embodiment, the third live video images may be obtained by filling the mask information in bits vacated in image areas of the first live video images, and the vacated bits may be obtained by performing a color space conversion on the first live video images. Decoding the live video stream to obtain the first live video images and the mask information may include steps S1021 and S1022.

At step S1021, the vacated bits are decoded to obtain the mask information.

The vacated bits are filled with the mask information, thus the mask information may be obtained by decoding the vacated bits.

At step S1022, areas other than the vacated bits in the image areas of the first live video images are decoded and then a color space inverse conversion is performed thereon to obtain the first live video images.

The areas other than the vacated bits are filled with the data of the first live video images after the color space conversion, thus the areas other than the vacated bits are decoded and then the color space inverse conversion is performed thereon. For example, if the color space conversion during encoding is to convert the RGB mode to the YUV mode, then the color space inverse conversion is to convert the YUV mode to the RGB mode. The first live video images may be obtained after the color space inverse conversion.

In another embodiment, the third live video images may be obtained by filling the mask information in space vacated in image areas of the first live video images, and the vacated space may be obtained by reducing resolutions or image sizes of the first live video images. Decoding the live video stream to obtain the first live video images and the mask information may include steps S102a and S102b.

At step S102a, the vacated space is decoded to obtain the mask information.

The vacated space is filled with the mask information, thus the mask information may be obtained by decoding the vacated space.

At step S102b, areas other than the vacated space in the image areas of the first live video images are decoded and then the resolutions or the image sizes thereof are restored to obtain the first live video images.

The areas other than the vacated space are filled with the data of the first live video images with reduced resolutions or image sizes, thus the areas other than the vacated space are decoded and then the resolutions or the image sizes thereof are restored. For example, if the resolutions of the first live video images are reduced from A to B during encoding, then the resolutions of the first live video images need to be restored from B to A after decoding. The first live video images may be obtained after the resolutions or the image sizes are restored.

As shown in FIG. 11, in an embodiment, receiving first live video images and mask information of the first live video images from a host client or a server during a live-streaming process may include steps S111-S113.

At step S111, a live video stream and the mask information in an extension field of the live video stream are received from the host client during the live-streaming process, where the live video stream is generated by encoding the first live video images.

The first live video images may be encoded to generate the live video stream. Optionally, the video stream may be a standard video stream, such as H264, MPEG, H26X, and so on. The mask information may be attached to the extension field of the live video stream. The audience client may receive the live video stream and the mask information.

At step S112, the live video stream is decoded to obtain the first live video images.

The first live video images may be obtained by decoding the live video stream.

At step S113, the mask information is obtained from the extension field of the live video stream.

The mask information may be stored in the extension field, and the mask information may be obtained by decoding the extension field.

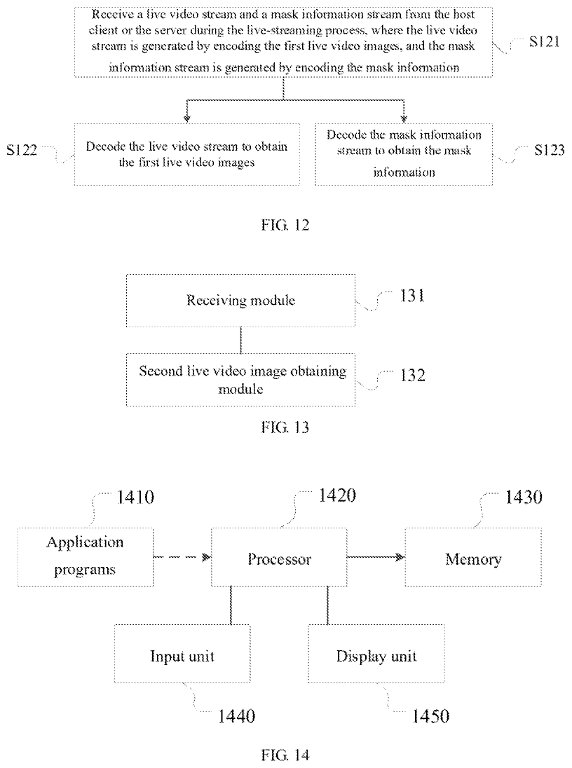

As shown in FIG. 12, in an embodiment, receiving first live video images and mask information of the first live video images from a host client or a server during a live-streaming process may include steps S121-S123.

At step S121, a live video stream and a mask information stream are received from the host client during the live-streaming process, where the live video stream is generated by encoding the first live video images, and the mask information stream is generated by encoding the mask information.

The first live video images may be encoded to generate the live video stream. Optionally, the video stream may be a standard video stream, such as H264, MPEG, H26X, and so on. The mask information may be separately encoded to generate the mask information stream. The audience client may receive the live video stream and the mask information stream.

At step S122, the live video stream is decoded to obtain the first live video images.

The first live video images may be obtained by decoding the live video stream.

At step S123, the mask information stream is decoded to obtain the mask information.

The mask information may be obtained by decoding the mask information stream. The mask information may be synchronized with the first live video image.

Based on the same inventive concept, the present disclosure also provides a live video image processing apparatus. Specific implementations of the apparatus according to the present disclosure will be described in detail below with reference to the drawings.

As shown in FIG. 13, in an embodiment, a live video image processing apparatus includes:

a receiving module 131, configured to receive first live video images and mask information of the first live video images from a host client or a server during a live-streaming process; and

a second live video image obtaining module 132, configured to obtain second live video images according to the first live video images and the mask information thereof.

The audience client may then adjust the first live video images based on the mask information to obtain the second live video images for display on the audience client.

The live video image processing apparatus according to this embodiment meets diversified needs of users, increases interest and enjoyment of a live streaming, improves user watching experience, and improves a playing effect of a live video.

Corresponding to the aforementioned four ways of transmitting the first live video images and the mask information, the audience client needs to perform corresponding decoding operations to obtain the first live video images and the mask information transmitted from the host client. The following description will be given in conjunction with four embodiments.

In the first embodiment, the receiving module 131 may include: a live video stream receiving unit, configured to receive a live video stream from the host client during the live-streaming process, where the live video stream is generated by encoding first image channels, and the first image channels are obtained by adding image channels for transmitting the mask information to original image channels of the first live video images; a decoding unit, configured to decode the live video stream to obtain the original image channels of the first live video images and the image channels for transmitting the mask information; a first live video image acquiring unit, configured to acquire the first live video images from the original image channels of the first live video images; and a mask information acquiring unit, configured to acquire the mask information from the image channels for transmitting the mask information.

In the second embodiment, the receiving module 131 may include: a live video stream receiving unit, configured to receive a live video stream from the host client during the live-streaming process, where the live video stream is generated by encoding third live video images, and the third live video images are obtained by mixing the mask information with the first live video images; and a decoding unit, configured to decode the live video stream to obtain the first live video images and the mask information.

Different ways of adding the mask information lead to different ways of decoding, which will be described below in conjunction with two embodiments.

In an embodiment, the third live video images may be obtained by filling the mask information in bits vacated in image areas of the first live video images, and the vacated bits may be obtained by performing a color space conversion on the first live video images. The decoding unit may be configured to decode the vacated bits to obtain the mask information; and decode areas other than the vacated bits in the image areas of the first live video images and then perform a color space inverse conversion thereon to obtain the first live video images.

In another embodiment, the third live video images may be obtained by filling the mask information in space vacated in image areas of the first live video images, and the vacated space may be obtained by reducing resolutions or image sizes of the first live video images. The decoding unit may be configured to decode the vacated space to obtain the mask information; and decode areas other than the vacated space in the image areas of the first live video images and then restore the resolutions or the image sizes thereof to obtain the first live video images.

In the third embodiment, the receiving module 131 may include: a data receiving unit, configured to receive a live video stream and the mask information in an extension field of the live video stream from the host client during the live-streaming process, where the live video stream is generated by encoding the first live video images; a decoding unit, configured to decode the live video stream to obtain the first live video images; and a mask information obtaining unit, configured to obtain the mask information from the extension field of the live video stream.

In the fourth embodiment, the receiving module 131 may include: a receiving unit, configured to receive a live video stream and a mask information stream from the host client during the live-streaming process, where the live video stream is generated by encoding the first live video images, and the mask information stream is generated by encoding the mask information; a first decoding unit, configured to decode the live video stream to obtain the first live video images; and a second decoding unit, configured to decode the mask information stream to obtain the mask information.

In order to better understand the above-described live video image processing method and apparatus, the following description will be given in conjunction with several application scenarios.

### Application Scenario 1

A host client or a server may generate mask information of live video images, and then transmit the live video images and the mask information to an audience client. The mask information may include a portrait area of a host in a live video image, that is to say, the host client or the server may generate the portrait area of the host in the live video image as the mask information. In addition, the host client or the server may also distribute a bullet screen comment from a live room of audience to each audience client in the live room. The mask information may be configured to use the portrait area of the host as a foreground area and the bullet screen comment as a part of a background area.

Bullet-screen operation controls may be provided in an interface of the audience client. The function of the bullet-screen operation controls may include whether to display the bullet screen comment, or whether to display the bullet screen comment behind a host portrait picture, etc.

Taking displaying no bullet screen comment as an example, when a command indicative of displaying no bullet screen comment is input through the bullet-screen operation controls, the audience client may remove the bullet screen comment (or remove the entire background area) from the live video image according to the mask information, such that the bullet screen comment is no longer displayed in the live video image. This may prevent the bullet screen comment from blocking the host portrait picture, thereby ensuring a playing effect of the live video image.

Taking displaying the bullet screen comment behind the host portrait picture as an example, when a command indicative of displaying the bullet screen comment behind the host portrait picture is input through the bullet-screen operation controls, the audience client may extract the host portrait picture and a background area picture including the bullet screen comment from the live video image according to the mask information, and superimpose the host portrait picture on the background area picture including the bullet screen comment for display. This may prevent the bullet screen comment from blocking the host portrait picture, thereby ensuring a playing effect of the live video image.

### Application Scenario 2

The host client may be provided with rich live-streaming backgrounds, such as a background having a special effect, a stylized background, a real-scene background, and a game screen background. The host may replace the background of the live video image at any time according to the live content, to enrich live-streaming scenes, increase the interest and enjoyment of the live streaming, and improve a live-streaming effect.

Taking the game screen background as an example, the host client may replace the host background with a game screen during the live-streaming process to obtain the live video image. The host client or the server may generate the mask information of the live video image, and then transmit the live video image and the mask information to the audience client. The mask information may be configured to use the host portrait as the foreground area and the game screen as the background area.

The audience client, after receiving the live video image and the mask information, may cut out the background area (that is, the game screen) from the live video image according to the mask information, then enter a customized foreground area image such as an audience portrait picture, and superimpose the customized foreground area image on the background area for display. In this way, a variety of live-streaming scenes may be provided for the audience client, which improves a live-streaming effect.

### Application Scenario 3

The audience client may be provided with rich live-streaming backgrounds, such as a background having a special effect, a stylized background, a real-scene background, and a game screen background. The audience may replace the background of the live video image at any time according to the live content, to enrich live-streaming scenes, increase the interest and enjoyment of the live streaming, and improve a live-streaming effect.

The host client or the server may generate the mask information of the live video image, and then transmit the live video image and the mask information to the audience client. The mask information may be configured to use the host portrait as the foreground area and an actual live-streaming scene as the background area.

The audience client, after receiving the live video image and the mask information, may cut out the foreground area (that is, the host portrait picture) from the live video image according to the mask information, then enter a customized background area image such as a game screen, and superimpose the host portrait picture on the customized background area image for display. In this way, the audience client may set the live-streaming scene by itself as needed, which improves a live-streaming effect.

### Application Scenario 4

The host client or the server may generate the mask information of the live video image, and then transmit the live video image and the mask information to the audience client. The mask information may be configured to use the host portrait as the foreground area and an actual live-streaming scene as the background area.

A trigger condition may be set for replacing with a background having a gift effect, so as to provide the background having the gift effect when the audience sends gifts. If the audience client detects that there is a gift from the audience in the live room after receiving the live video image and the mask information, the audience client may cut out the actual live-streaming scene front the live video image according to the mask information, and replace the actual live-streaming scene with the background having the gift effect for display. In this way, user consumption may be stimulated, interest of the live streaming may be increased, a live-streaming effect may be improved, and a retention rate of users may be improved.

The embodiments of the present disclosure also provide a computer-readable storage medium in which a computer program is stored, and the computer program, when executed by a processor, causes the processor to implement any of the live video image processing methods as described above. The storage medium includes but is not limited to any type of disk (including floppy disk, hard disk, optical disk, CD-ROM, and magneto-optical disk), ROM (Read-Only Memory), RAM (Random Access Memory), EPROM (Erasable Programmable Read-Only Memory), EEPROM (Electrically Erasable Programmable Read-Only Memory), flash memory, magnetic card or optical card. That is, the storage medium includes any medium that stores or transmits information in a readable form by a device (for example, a computer), which may be a read-only memory, a magnetic disk or an optical disk, etc.

The embodiments of the present disclosure also provide a computer device including: one or more processors; and a memory configured to store one or more programs, where the one or more programs, when executed by the one or more processors, cause the one or more processors to implement any of the live video image processing methods as described above.

FIG. 14 is a schematic structural diagram of a computer device according to the present disclosure, which includes a processor 1420, a memory 1430, an input unit 1440, a display unit 1450 and other components. Those skilled in the art may understand that the structural components shown in FIG. 14 do not constitute a limitation on all computer devices, and more or less components than those shown in the figure may be included, or certain components may be combined. The memory 1430 may be configured to store application programs 1410 and various functional modules. The processor 1420 may execute the application programs 1410 stored in the memory 1430 to perform various functional applications of the device and data processing. The memory 1430 may include an internal memory or an external memory, or include both of the internal memory and the external memory. The internal memory may include read-only memory (ROM), programmable ROM (PROM), electrically programmable ROM (EPROM), electrically erasable programmable ROM (EEPROM), flash memory, or random access memory. The external memory may include hard disk, floppy disk, ZIP disk, USB flash drive, magnetic tape, etc. The memory 1430 of the present disclosure includes, but is not limited to, these types of memory. The memory 1430 of the present disclosure is merely an example and not a limitation.

The input unit 1440 is configured to receive signal input, and receive the first live video images, and so on. The input unit 1440 may include a touch panel and other input devices. The touch panel may collect user touch operations on or near it (for example, user operations on the touch panel or near the touch panel with fingers, a stylus and any other suitable objects or accessories), and drive a corresponding connection apparatus according to a preset program. Other input devices may include, but are not limited to, one or more of a physical keyboard, function keys (such as play control buttons, and switch buttons), a trackball, a mouse, a joystick, and the like. The display unit 1450 may be configured to display information input by the user or information provided to the user and various menus of the computer device. The display unit 1450 may be in the form of a liquid crystal display, an organic light-emitting diode, or the like. The processor 1420, as a control center of the computer device, may utilize various interfaces and circuits to connect various parts of the entire computer, and run or execute software programs and/or modules stored in the memory 1430 and invoke data stored in the memory to perform various functions and data processing.

In an embodiment, the computer device may include one or more processors 1420, one or more memory 1430, and one or more application programs 1410, where the one or more application programs 1410 are stored in the memory 1430, and configured to be executable by the one or more processors 1420, to perform the live video image processing methods described in the above embodiments.

With the above-described live video image processing method and apparatus, storage medium, and computer device, not only first live video images collected during a live-streaming process may be transmitted to an audience client, but also mask information may be generated for the first live video images during the live-streaming process and transmitted to the audience client together with the first live video images, such that the audience client may perform a desired operation on the first live video images according to the mask information, for example, change a live-streaming background or a live-streaming foreground of the first live video image according to the mask information, etc. Therefore, diversified playing contents of a live video may be realized and a playing effect of the live video may be improved.

It should be understood that, although various steps in a flowchart in the drawings are shown in order as indicated by arrows, these steps are not necessarily performed in the order as indicated by the arrows. Unless explicitly stated herein, there is no strict order for performing of these steps, and these steps may be performed in other orders. Moreover, at least a part of the steps in the flowchart in the drawings may include multiple sub-steps or multiple stages, which are not necessarily performed at the same time, but may be performed at different times, and are not necessarily performed in order, but may be performed alternately with other steps or at least a part of the sub-steps or stages of other steps.

It should be understood that, functional units in various embodiments of the present disclosure may be integrated into a single processing module, or each of the units may exist physically alone, or two or more of the units may be integrated into a single module. The integrated module may be implemented in the form of hardware or software functional modules.

The above are merely part of the embodiments of the present disclosure. It should be noted that, several improvements and modifications may be made by those ordinary skilled in the art without departing from the principle of the present disclosure, and such improvements and modifications should also be regarded as falling within the protection scope of the present disclosure.

1. A video image processing method, comprising:
acquiring first video images;
generating mask information of the first video images in response to a mask information generation command; and
transmitting the first video images and the mask information to an audience client, such that the audience client obtains second video images according to the first video images and the mask information.

2. The method of claim 1, wherein the transmitting the first video images and the mask information to an audience client comprises:
obtaining first image channels by adding image channels for transmitting the mask information to original image channels of the first video images;
encoding the first image channels to generate a video stream; and
transmitting the video stream to the audience client.

3. The method of claim 1, wherein the transmitting the first video images and the mask information to an audience client comprises:
mixing the mask information with the first video images to obtain third video images;
encoding the third video images to generate a video stream; and
transmitting the video stream to the audience client.

4. The method of claim 3, wherein the mixing the mask information with the first video images to obtain third video images comprises:
performing a color space conversion on the first video images to vacate bits in image areas of the first video images; and
filling the mask information in the vacated bits to obtain the third video images.

5. The method of claim 3, wherein the mixing the mask information with the first video images to obtain third video images comprises:
reducing resolutions and/or image sizes of the first video images to vacate space in image areas of the first video images; and
filling the mask information in the vacated space to obtain the third video images.

6. The method of claim 1, wherein the transmitting the first video images and the mask information to an audience client comprises:
encoding the first video images to generate a video stream;
filling the mask information in an extension field of the video stream to obtain an extended video stream; and
transmitting the extended video stream to the audience client.

7. The method of claim 1, wherein the transmitting the first video images and the mask information to an audience client comprises:
encoding the first video images to generate a video stream;
encoding the mask information to generate a mask information stream; and
transmitting the video stream and the mask information stream to the audience client.

8. The method of any of claims 1-7, wherein the first video images comprise a video image and a bullet screen comment corresponding to the video image.

9. The method of any of claims 1-8, wherein
the first video images are video images acquired by a live-streaming client in real time during a live-streaming process, or
the first video images are recorded video images pre-stored in a server or the live-streaming client.

10. A video image processing method, comprising:
receiving first video images and mask information of the first video images from a host client or a server; and
obtaining second video images according to the first video images and the mask information.

11. The method of claim 10, wherein the receiving first video images and mask information of the first video images from a host client or a server comprises:
receiving a video stream from the host client or the server, wherein the video stream is generated by encoding first image channels, and the first image channels are obtained by adding image channels for transmitting the mask information to original image channels of the first video images;
decoding the video stream to obtain the original image channels of the first video images and the image channels for transmitting the mask information;
acquiring the first video images from the original image channels of the first video images; and
acquiring the mask information from the image channels for transmitting the mask information.

12. The method of claim 10, wherein the receiving first video images and mask information of the first video images from a host client or a server comprises:
receiving a video stream from the host client or the server, wherein the video stream is generated by encoding third video images, and the third video images are obtained by mixing the mask information with the first video images; and
decoding the video stream to obtain the first video images and the mask information.

13. The method of claim 12, wherein
the third video images are obtained by filling the mask information in bits vacated in image areas of the first video images, and the vacated bits are obtained by performing a color space conversion on the first video images;
the decoding the video stream to obtain the first video images and the mask information comprises:
decoding the vacated bits to obtain the mask information; and
decoding areas other than the vacated bits in the image areas of the first video images and then performing a color space inverse conversion thereon to obtain the first video images.

14. The method of claim 12, wherein
the third video images are obtained by filling the mask information in space vacated in image areas of the first video images, and the vacated space is obtained by reducing resolutions or image sizes of the first video images;
the decoding the video stream to obtain the first video images and the mask information comprises:
decoding the vacated space to obtain the mask information; and
decoding areas other than the vacated space in the image areas of the first video images and then restoring the resolutions or the image sizes thereof to obtain the first video images.

15. The method of claim 10, wherein the receiving first video images and mask information of the first video images from a host client or a server comprises:
receiving a video stream and the mask information in an extension field of the video stream from the host client or the server, wherein the video stream is generated by encoding the first video images;
decoding the video stream to obtain the first video images; and
obtaining the mask information from the extension field of the video stream.

16. The method of claim 10, wherein the receiving first video images and mask information of the first video images from a host client or a server comprises:
receiving a video stream and a mask information stream from the host client or the server, wherein the video stream is generated by encoding the first video images, and the mask information stream is generated by encoding the mask information;
decoding the video stream to obtain the first video images; and
decoding the mask information stream to obtain the mask information.

17. The method of any of claims 10-16, wherein the first video images comprise a video image and a bullet screen comment corresponding to the video image.

18. The method of any of claims 10-17, wherein
the first video images are video images generated by the live-streaming client in real time during a live-streaming process, or
the first video images are recorded video images pre-stored in the server or the live-streaming client.

19. The method of claim 10, wherein the obtaining second video images according to the first video images and the mask information comprises:
extracting foreground areas and background areas from the first video images according to the mask information;
replacing the foreground areas with desired foreground area images; and
superimposing the desired foreground area images and the background areas to obtain the second video images.

20. The method of claim 10, wherein the obtaining second video images according to the first video images and the mask information comprises:
extracting foreground areas and background areas from the first video images according to the mask information;
replacing the background areas with desired background area images; and
superimposing the desired background area images and the foreground areas to obtain the second video images.

21. A video image processing apparatus, comprising:
a first video image acquiring module, configured to acquire first video images;
a mask information generating module, configured to generate mask information of the first video images in response to a mask information generation command; and
a transmitting module, configured to transmit the first video images and the mask information to an audience client, such that the audience client obtains second video images according to the first video images and the mask information.

22. A video image processing apparatus, comprising:
a receiving module, configured to receive first video images and mask information of the first video images from a host client or a server; and
a second video image obtaining module, configured to obtain second video images according to the first video images and the mask information.

23. A computer-readable storage medium storing a computer program, wherein the computer program, when executed by a processor, causes the processor to implement the video image processing method of any of claims 1-20.

24. A computer device, comprising:
one or more processors; and
a memory configured to store one or more programs, wherein the one or more programs, when executed by the one or more processors, cause the one or more processors to implement the video image processing method of any of claims 1-20.
